(19) United States
(12) Patent Application Publication
(10) Pub. No.: US 2025/0389641 A1
(43) Pub. Date: Dec. 25, 2025

(54) MEASUREMENT APPARATUS AND METHOD BASED ON PHOTON NUMBER RESOLVING DETECTOR

(71) Applicant: NATIONAL INSTITUTE OF METROLOGY, CHINA, Beijing (CN)

(72) Inventors: Haiyong GAN, Beijing (CN); Xiangliang LIU, Beijing (CN); Nan XU, Beijing (CN); Yingwei HE, Beijing (CN)

(21) Appl. No.: 18/879,754

(22) PCT Filed: Aug. 28, 2023
(86) PCT No.: PCT/CN2023/115247

§ 371 Date: Dec. 28, 2024

(30) Foreign Application Priority Data
Aug. 30, 2022 (CN) 202211058589.1

(51) Int. Cl. G01N 21/17; G01J 11/00; G01N 21/13

(52) U.S. Cl. CPC G01N 21/1717; G01J 11/00; G01N 21/13; G01N 2021/135; G01N 2021/1721; G01N 2021/1725; G01N 2021/1727; G01N 2021/1731

(57) ABSTRACT

A measurement apparatus and method based on a photon number resolving detector (3). The measurement apparatus comprises a sample holder (1), a coherent light source (2), and the photon number resolving detector (3). The sample holder (1) is configured to be able to receive a sample (200), and is further configured to be able to accommodate the sample (200) for chemical reaction, adjust the temperature of the sample (200), and adjust the mechanical and motion states of the sample (200). The coherent light source (2) is configured to be able to emit incident light towards the sample (200) on the sample holder (1). The photon number resolving detector (3) is configured to be able to measure data of transmitted light, reflected light, and scattered light passing through the sample (200) on the sample holder (1) and perform statistics and analysis so as to obtain statistical photon characteristics of the transmitted light, the reflected light, and the scattered light.

### CROSS-REFERENCES TO RELATED APPLICATIONS

The present application claims priority to Chinese Patent Application No. 2022110585891, filed on Aug. 30, 2022, entitled “Measurement Apparatus and Method Based on Photon Number Resolving Detector”, which is hereby incorporated by reference in its entirety.

### FIELD

The present application relates to the field of photon-number-resolving detector, and in particular to a measurement device and a measurement method based on a photon-number-resolving detector.

### BACKGROUND

With the rapid development of photo-detection technologies, characteristics of weak light have been measured and analyzed, and a photon-number-resolving detector is a main measurement device. When weak light is incident on the photon-number-resolving detector, the photon-number-resolving detector may generate a response signal corresponding to the number of photons to analyze photon statistical properties of the incident light. The photon-number-resolving detector is widely used in quantum communication, laser radar and other fields since it has photon number resolution capability. However, the photon-number-resolving detector has relatively limited application in the measurement field in the related art.

### BRIEF SUMMARY

The present application provides a measurement device and a measurement method based on a photon-number-resolving detector, which may solve a problem that the photon-number-resolving detector has relatively limited application in the measurement field in the related art.

In an embodiment, the present application provides a measurement device based on a photon-number-resolving detector, including:
a sample holder, configured to receive a sample, and further configured to accommodate the sample for performing chemical reaction, adjusting a temperature of the sample, and adjusting a mechanical and motion state of the sample;
a coherent light source, configured to emit incident light to the sample on the sample holder; and
a photon-number-resolving detector, configured to measure data of transmitted light, reflected light and scattered light passing through the sample on the sample holder and perform statistics and analysis on the data to obtain photon statistical properties of the transmitted light, reflected light and scattered light.

According to the measurement device based on the photon-number-resolving detector provided by the present application, the sample holder includes a sample stage and a temperature adjuster, the sample stage is configured to place the sample, the temperature adjuster is arranged on the sample stage, and the temperature adjuster is configured to adjust the temperature of the sample on the sample stage.

According to the measurement device based on the photon-number-resolving detector provided in the present application, the temperature adjuster is configured to apply one or more of current, voltage, an acoustic field, a magnetic field or an electromagnetic wave to the sample on the sample stage for adjusting the temperature of the sample.

According to the measurement device based on the photon-number-resolving detector provided in the present application, the sample holder further includes a motion mechanism, where the motion mechanism is connected to the sample stage, and the motion mechanism is configured to drive the sample stage to perform at least one of vibration, rotation or translation.

According to the measurement device based on the photon-number-resolving detector provided in the present application, the sample holder further includes a loading mechanism, where the loading mechanism is arranged on the sample stage, and the loading mechanism is configured to perform a loading operation of squeezing and/or stretching on the sample on the sample stage.

According to the measurement device based on the photon-number-resolving detector provided in the present application, the coherent light source is a laser or a narrow-band filtered light-emitting diode.

According to the measurement device based on the photon-number-resolving detector provided by the present application, the photon-number-resolving detector is any one of a superconducting transition-edge sensor, a superconducting nanowire array, a microwave dynamic inductance detector, a time division multiplexing photon-number-resolving detector, a frequency division multiplexing photon-number-resolving detector, a differential detection photon-number-resolving detector, or a spatial array photon-number-resolving detector.

According to the measurement device based on the photon-number-resolving detector provided by the present application, both the coherent light source and the photon-number-resolving detector are configured to be movable relative to the sample holder for adjusting relative positions of both the coherent light source and the photon-number-resolving detector and the sample holder.

In an embodiment, the present application further provides a measurement method based on a photon-number-resolving detector performed by a measurement device based on a photon-number-resolving detector mentioned above, including:
placing a sample on a sample holder, and performing one or more operations of controlling the sample to perform chemical reactions, adjusting a temperature of the sample, and adjusting a mechanical and motion state of the sample;
controlling a coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light to obtain one or more of correspondences among a chemical composition and a reaction process, a temperature, a mechanical and motion state of the sample and the photon statistical properties of the transmitted light, the reflected light, and the scattered light.

According to the measurement method based on the photon-number-resolving detector provided by the present application, the method further includes:
placing the sample on the sample holder;
controlling a coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light based on correspondences among the chemical composition and the reaction process, the temperature, the mechanical and motion state of the sample and the photon statistical properties of the transmitted light, the reflected light, and the scattered light to obtain one or more of a current chemical composition and a current reaction process, a current temperature or a current mechanical and motion state of the sample.

In the measurement device and the measurement method based on the photon-number-resolving detector provided by the present application, the sample is received through the sample holder, incident light is emitted toward the sample through the coherent light source, the photon statistical properties are obtained using the photon-number-resolving detector. The photon-number-resolving detector measures the data of the transmitted light, the reflected light and scattered light passing through the sample, and performs statistical analysis on the data to obtain the photon statistical properties of the transmitted light, the reflected light and the scattered light. The chemical composition, the reaction process, the temperature, the mechanical and motion state of the sample are measured based on the photon-number-resolving detector. By providing the sample holder to be adjustable, the sample is under different temperatures, different mechanical and motion states, different chemical compositions and reaction process, and the photon-number-resolving detector is used to measure the data of the transmitted light, reflected light and scattered light passing through the sample under different temperatures, different mechanical and motion states, different chemical compositions and reaction process, and to perform statistical analysis on the data to obtain the photon statistical properties of the transmitted light, the reflected light and the scattered light. As such, the correspondences among the chemical compositions and the reaction process, the temperatures, the mechanical and motion states of the sample and the photon statistical properties of the transmitted light, the reflected light, and the scattered light are measured based on the photon-number-resolving detector. The measurement device and the measurement method based on the photon-number-resolving detector of the present application may extend an application field of the photon-number-resolving detector and effectively solve the problem that the photon-number-resolving detector has relatively limited application in the measurement field in the related art.

### BRIEF DESCRIPTION OF THE DRAWINGS

In order to illustrate the solutions in the embodiments of the present application or in the related art more clearly, the drawings used in the description of the embodiments or the related art are briefly described below. The drawings in the following description are only some embodiments of the present application, and other drawings may be obtained according to these drawings without any creative work for those skilled in the art.

FIG. 1 is a schematic structural diagram of a measurement device based on the photon-number-resolving detector according to the present application; and

FIG. 2 is a schematic flow chart of a measurement method based on the photon-number-resolving detector according to the present application.

### REFERENCE NUMERALS

1: sample stage; 2: coherent light source; 3: photon-number-resolving detector; 200: sample.

### DETAILED DESCRIPTION

In order to illustrate the objects, solutions and advantages of the application, the solutions in present the application will be described clearly and completely below in combination with the drawings in the application. The described embodiments are part of the embodiments of the application, not all of them. All other embodiments obtained by a person of ordinary skill in the art based on the embodiments of the present application without any creative work belong to the scope of the present application.

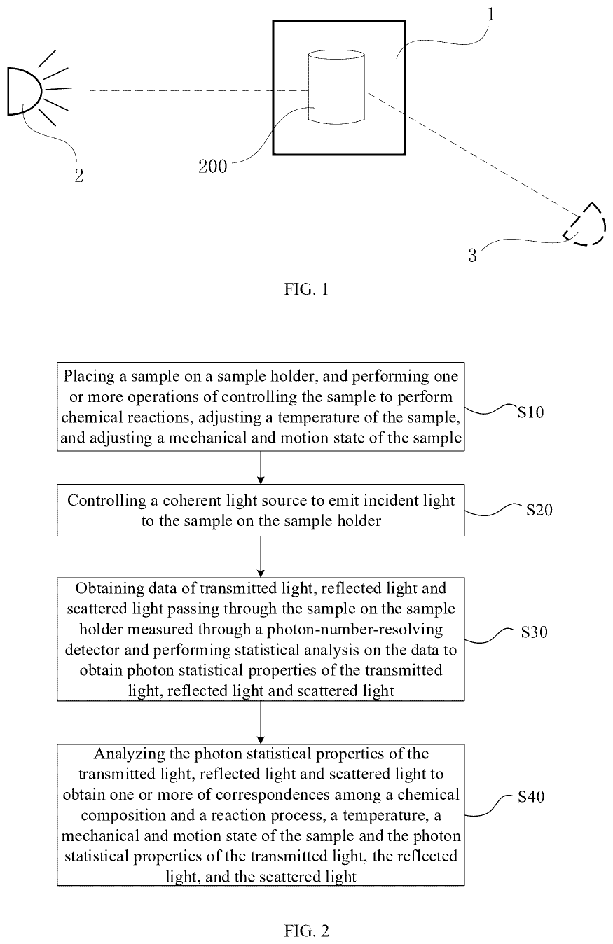

As shown in FIG. 1, a measurement device based on the photon-number-resolving detector of the present application includes a sample holder 1, a coherent light source 2 and a photon-number-resolving detector 3. The sample holder 1 is configured to receive a sample 200, and further configured to accommodate the sample 200 for performing chemical reaction, adjusting a temperature of the sample 200, and adjusting a mechanical and motion state of the sample 200. The coherent light source 2 is configured to emit incident light to the sample 200 on the sample holder 1. The photon-number-resolving detector 3 is configured to measure data of transmitted light, reflected light and scattered light passing through the sample 200 on the sample holder 1 and perform statistics and analysis on the data to obtain photon statistical properties of the transmitted light, reflected light and scattered light.

In this embodiment, the sample holder 1 is used to receive the sample 200, and the sample 200 may be solid, liquid or gas, and the sample 200 may be mounted, placed or accommodated on the sample holder 1. The coherent light source 2 is used to emit incident light toward the sample 200 on the sample holder 1; the photon-number-resolving detector 3 has a capability to performing photon statistics. Photon statistics is a property to reflect the light field through the statistical distribution of the number of photons. The data measured by the photon-number-resolving detector 3 includes voltage and current, etc., and the photon statistical properties are obtained by statistically analyzing the voltage and current data. The data of transmitted light, reflected light and scattered light passing through the sample 200 is measured through a photon-number-resolving detector 3 and statistical analysis is performed on the data to obtain photon statistical properties of the transmitted light, reflected light and scattered light passing through the sample 200.

The sample 200 may have a capability to react with a certain chemical substance, the sample holder 1 may accommodate the sample 200 for performing chemical reaction, and the chemical composition and the reaction process of the sample 200 have a specific correspondence with the photon statistical properties of the transmitted light, the reflected light and the scattered light passing through the sample 200. In case that the correspondence among the chemical composition and the reaction process of the sample 200 and the photon statistical properties of the transmitted light, the reflected light and the scattered light is known, the sample 200 is placed on the sample holder 1, and the incident light emitted from the coherent light source 2 is irradiated onto the sample 200. The data of the transmitted light, the reflected light and the scattered light passing through the sample 200 is measured and statistical analysis is performed on the data to obtain the photon statistical properties of the transmitted light, the reflected light and the scattered light. The composition, the concentration and the reaction process of the current chemical substance of the sample 200 and other properties are further obtained based on the above-mentioned known correspondence. In case that the correspondence among the chemical composition and the reaction process of the sample 200 and the photon statistical properties of the transmitted light, the reflected light and the scattered light is unknown, the sample 200 is placed on the sample holder 1, and the sample 200 is controlled to perform chemical reactions and other operations. The incident light emitted from the coherent light source 2 is irradiated on the sample 200. The data of the transmitted light, reflected light and scattered light passing through the sample 200 is measured through the photon-number-resolving detector 3 under different chemical compositions and reaction process conditions, and statistical analysis is performed on the data to obtain corresponding photon statistical properties of the transmitted light, the reflected light and the scattered light. As such, the correspondences among the chemical composition and the reaction process of the sample 200 and the photon statistical properties of the transmitted light, the reflected light and the scattered light are obtained.

Optical property parameters of the sample 200, such as a transmittance, a reflectance ratio, a scattering ratio, and a refractive index, are sensitive to temperature and there is a specific correspondence between the temperature of the sample 200 and the photon statistical properties of the transmitted light, the reflected light and the scattered light passing through the sample 200. The sample holder 1 further has the function of adjusting the temperature, and may adjust the temperature of the sample 200. In case that the correspondence between the temperature of the sample 200 and the photon statistical properties of the transmitted light, the reflected light and the scattered light is known, the sample 200 is placed on the sample holder 1, and the incident light emitted from the coherent light source 2 is irradiated onto the sample 200. The data of the transmitted light, the reflected light and the scattered light passing through the sample 200 is measured, and statistical analysis is performed on the data to obtain the photon statistical properties of the transmitted light, the reflected light and the scattered light. The current temperature of the sample 200 and other properties are further obtained based on the above-mentioned known correspondence. In case that the correspondence between the temperature of the sample 200 and the photon statistical properties of the transmitted light, the reflected light and the scattered light is unknown, the sample 200 is placed on the sample holder 1, and the temperature of the sample 200 is adjusted. The incident light emitted from the coherent light source 2 is irradiated on the sample 200. The data of the transmitted light, reflected light and scattered light passing through the sample 200 is measured through the photon-number-resolving detector 3 under different temperature conditions, and statistical analysis is performed on the data to obtain corresponding photon statistical properties of the transmitted light, the reflected light and the scattered light. As such, the correspondences between the temperature of the sample 200 and the photon statistical properties of the transmitted light, the reflected light and the scattered light are obtained.

The optical property parameters such as transmittance, reflectance ratio, scattering ratio, refractive index, etc. of the sample 200 are further sensitive to the mechanical and motion state. There is a specific correspondence between the mechanical and motion state of the sample 200 and the photon statistical properties of the transmitted light, the reflected light and the scattered light passing through the sample 200. The sample holder 2 may further adjust the mechanical and motion state of the sample 200. By adjusting the mechanical and motion state of the sample 200, the optical property parameters such as transmittance, reflectance ratio, scattering ratio, refractive index, etc. of the sample 200 are changed. In case that the correspondence between the mechanical and motion state of the sample 200 and the photon statistical properties of the transmitted light, the reflected light and the scattered light is known, the sample 200 is placed on the sample holder 1, and the incident light emitted from the coherent light source 2 is irradiated onto the sample 200. The data of the transmitted light, the reflected light and the scattered light passing through the sample 200 is measured and statistical analysis is performed on the data to obtain the photon statistical properties of the transmitted light, the reflected light and the scattered light. The current mechanical and motion state of the sample 200 and other properties are further then obtained based on the above-mentioned known correspondence. In case that the correspondence between the mechanical and motion state of the sample 200 and the photon statistical properties of the transmitted light, the reflected light and the scattered light is unknown, the sample 200 is placed on the sample holder 1, and the mechanical and motion state of the sample 200 is adjusted. The incident light emitted from the coherent light source 2 is irradiated on the sample 200. The data of the transmitted light, reflected light and scattered light passing through the sample 200 is measured through the photon-number-resolving detector 3 under different mechanical and motion state conditions, and statistical analysis is performed on the data to obtain corresponding photon statistical properties of the transmitted light, the reflected light and the scattered light. As such, the correspondences between the mechanical and motion state of the sample 200 and the photon statistical properties of the transmitted light, the reflected light and the scattered light are obtained.

In the measurement device based on the photon-number-resolving detector provided by the present application, the sample 200 is received through the sample holder 1, incident light is emitted toward the sample through the coherent light source, the photon statistical properties are obtained using the photon-number-resolving detector 3. The photon-number-resolving detector 3 measures the data of the transmitted light, the reflected light and scattered light passing through the sample 200, and performs statistical analysis on the data to obtain the photon statistical properties of the transmitted light, the reflected light and the scattered light. The current chemical composition and the reaction process, the temperature, the mechanical and motion state of the sample 200 are then obtained based on the known correspondences among the chemical composition and the reaction process, temperature, mechanical and motion state of the sample 200 and the photon statistical properties of the transmitted light, the reflected light and the scattered light, and the measurement of the chemical composition and the reaction process, the temperature and mechanical and motion state of the sample 200 based on the photon number resolution detector 3 is implemented. By providing the sample holder 1 to be adjustable, the sample 200 is under different temperatures, different mechanical and motion states, different chemical compositions and reaction process, and the photon-number-resolving detector 3 is used to measure the data of the transmitted light, reflected light and scattered light passing through the sample 200 under different temperatures, different mechanical and motion states, different chemical compositions and reaction process, and to perform statistical analysis on the data to obtain the photon statistical properties of the transmitted light, the reflected light and the scattered light. As such, the correspondences among the chemical compositions and the reaction process, the temperatures, the mechanical and motion states of the sample 200 and the photon statistical properties of the transmitted light, the reflected light, and the scattered light are further obtained, and the measurement of the correspondences among the chemical compositions and the reaction process, the temperatures, the mechanical and motion states of the sample 200 and the photon statistical properties of the transmitted light, the reflected light, and the scattered light based on the photon-number-resolving detector 3 is implemented. The measurement device based on the photon-number-resolving detector of the present application may extend an application field of the photon-number-resolving detector 3 and effectively solve the problem that the photon-number-resolving detector 3 has relatively limited application in the measurement field in the related art.

In an embodiment, the coherent light source 2 is a laser or a narrow-band filtered light-emitting diode. The laser and the narrow-band filtered light-emitting diode have stable power and good coherence properties, which ensures that the coherent light source 2 may provide incident light with stable power and good coherence properties.

In an embodiment, the photon-number-resolving detector is any one of a superconducting transition-edge sensor, a superconducting nanowire array, a microwave dynamic inductance detector, a time division multiplexing photon-number-resolving detector, a frequency division multiplexing photon-number-resolving detector, a differential detection photon-number-resolving detector, or a spatial array photon-number-resolving detector.

In an embodiment, both the coherent light source 2 and the photon-number-resolving detector 3 are configured to be movable relative to the sample holder 1 for adjusting the relative positions of both the coherent light source 2 and the photon-number-resolving detector 3 and the sample holder 1.

In this embodiment, by adjusting the relative positions of the coherent light source 2 and the photon-number-resolving detector 3 and the sample holder 1, an incident angle and an incident position of the incident light emitted from the coherent light source 2 on the sample 200 may be adjusted, and receiving positions and receiving angles of the photon-number-resolving detector 3 receiving the transmitted light, the reflected light and scattered light passing through the sample 200 may be adjusted, which is conducive to adjusting the coherent light source 2 and the photon-number-resolving detector 3 to the best position with the highest measurement accuracy. The measurement device may be applied to the measurement of various types of samples 200 and have more flexible use and wider application range.

In an embodiment, the sample holder 1 includes a sample stage and a temperature adjuster, the sample stage is configured to place the sample 200, the temperature adjuster is arranged on the sample stage, and the temperature adjuster is configured to adjust the temperature of the sample 200 on the sample stage.

In this embodiment, the sample stage is used to mount, place or accommodate the sample 200. By providing the temperature adjuster, the function of adjusting the temperature of the sample 200 is implemented. The temperature adjuster, in combination with the coherent light source 2 and the photon-number-resolving detector 3, is used to measure the data of the transmitted light, the reflected light and the scattered light passing through the sample 200 under different temperature conditions and perform statistical analysis on the data.

In an embodiment, the temperature adjuster includes at least one of an electric heating device, an acoustic wave heating device or an electromagnetic wave heating device. The temperature adjuster adjusts the temperature of the sample 200 by electric heating, acoustic wave heating, electromagnetic wave heating and the like.

In an embodiment, the temperature adjuster may adjust the temperature of the sample 200 by heat exchange, such as radiation heat exchange, contact heat exchange, convection heat exchange and the like.

In another embodiment, the temperature adjuster is configured to apply one or more of current, voltage, an acoustic field, a magnetic field or electromagnetic wave to the sample 200 on the sample stage to adjust the temperature of the sample 200.

In this embodiment, the temperature of the sample 200 is sensitive to external conditions such as current, voltage, acoustic field, the magnetic field or the electromagnetic wave, and one or more of the current, the voltage, the acoustic field, the magnetic field or the electromagnetic wave are applied to the sample 200 through the temperature adjuster to directly adjust the temperature of the sample 200. In case that the correspondences between the temperature of the sample 200 and the external conditions such as the current, the voltage, the acoustic field, the magnetic field or electromagnetic wave is known, and the correspondence between the temperature of the sample 200 and the photon statistical properties of the transmitted light, the reflected light and the scattered light is known, the sample 200 is placed on the sample holder 1, and the incident light emitted from the coherent light source 2 is irradiated on the sample 200. The photon-number-resolving detector 3 is used to measure the data of the transmitted light, the reflected light and the scattered light passing through the sample 200, and statistical analysis is performed on the data to obtain the photon statistical properties of the transmitted light, the reflected light and the scattered light, and the current temperature of the sample 200 is then obtained based on the above known correspondences, and the intensity of the external conditions such as the current, the voltage, the acoustic field, the magnetic field, the electromagnetic wave and the like that change the temperature of the sample 200 is further obtained. In case that the correspondences between the temperature of the sample 200 and external conditions such as the current, the voltage, the acoustic field, the magnetic field or the electromagnetic wave is unknown, and/or the correspondence between the temperature of the sample 200 and the photon statistical properties of the transmitted light, the reflected light and the scattered light is unknown, the sample 200 is placed on the sample holder 1, and the intensity of the external conditions such as the current, the voltage, the acoustic field, magnetic field, the electromagnetic wave applied to the sample 200 is adjusted, and the incident light emitted from the coherent light source 2 is irradiated on the sample 200. The data of the transmitted light, the reflected light and the scattered light passing through the sample 200 under different external intensity conditions are measured through the photon-number-resolving detector 3, and statistical analysis is performed on the data to obtain the photon statistical properties of the transmitted light, the reflected light and the scattered light, the correspondence between the temperature of the sample 200 and external conditions such as the current, the voltage, the acoustic field, the magnetic field or the electromagnetic wave is obtained, and the correspondence between the temperature of the sample 200 and the photon statistical properties of the transmitted light, the reflected light and the scattered light is further obtained. Therefore, the application field of the photon-number-resolving detector 3 is further extended, and the practicality is stronger.

In an embodiment, the sample holder 1 further includes a motion mechanism, where the motion mechanism is connected to the sample stage, and the motion mechanism is configured to drive the sample stage to perform at least one of vibration, rotation or translation.

In this embodiment, the optical property parameters of the sample 200, such as a transmittance, a reflectance ratio, a scattering ratio, and a refractive index, are sensitive to motion states such as vibration and rotation. By providing the motion mechanism, the sample stage is driven to perform at least one of vibration, rotation, and translation, and the sample 200 is placed on the sample stage, and the sample stage drives the sample 200 to perform vibration, rotation, or translation synchronously, the function of adjusting the motion state of the sample 200 is implemented, and the optical property parameters of the sample 200, such as the transmittance, the reflectance ratio, the scattering ratio, and the refractive index are changeable. In case that the correspondence between the vibration, rotation, translation and other motion states of the sample 200 and the photon statistical properties of the transmitted light, the reflected light and the scattered light is unknown, the sample 200 is placed on the sample holder 1, and the vibration, rotation, translation and other motion states of the sample 200 is adjusted through the motion mechanism. The incident light emitted from the coherent light source 2 is irradiated on the sample 200. Data of the transmitted light, reflected light and scattered light passing through the sample 200 is measured through the photon-number-resolving detector 3 under different motion states and statistical analysis is performed on the data to obtain corresponding photon statistical properties of the transmitted light, the reflected light and the scattered light. As such, the correspondences between the vibration, rotation, translation and other motion states of the sample 200 and the photon statistical properties of the transmitted light, the reflected light and the scattered light are obtained.

In an embodiment, the sample holder 1 further includes a loading mechanism, where the loading mechanism is arranged on the sample stage, and the loading mechanism is configured to perform a loading operation of squeezing and/or stretching on the sample 200 on the sample stage.

In this embodiment, the optical property parameters of the sample 200, such as a transmittance, a reflectance ratio, a scattering ratio, and a refractive index, are sensitive to mechanical states such as extrusion and stretching. By providing the loading mechanism, the sample 200 is subjected to extrusion and/or stretching loading operations, to adjust of the mechanical state of the sample 200, and the optical property parameters of the sample 200, such as the transmittance, the reflectance ratio, the scattering ratio, and the refractive index, are changeable. In case that the correspondence between the mechanical states of the sample 200, such as extrusion and stretching and the photon statistical properties of the transmitted light, the reflected light and the scattered light is unknown, the sample 200 is placed on the sample stage, and the mechanical states of the sample 200, such as extrusion and stretching is adjusted through the loading mechanism. The incident light emitted from the coherent light source 2 is irradiated on the sample 200. The data of the transmitted light, reflected light and scattered light passing through the sample 200 is measured through the photon-number-resolving detector 3 under different mechanical states and statistical analysis is performed on the data to obtain corresponding photon statistical properties of the transmitted light, the reflected light and the scattered light. As such, the correspondences between the mechanical states of the sample 200, such as extrusion and stretching and the photon statistical properties of the transmitted light, the reflected light and the scattered light are obtained.

Furthermore, the measurement device based on the photon-number-resolving detector further includes a controller, the controller is connected to the photon-number-resolving detector 3, the coherent light source 2 and the sample holder 1. The controller is used to control the operation and spatial position of the sample holder 1 and the coherent light source 2, and to obtain the data measured by the photon-number-resolving detector 3 and perform statistical analysis on the data to obtain the photon statistical properties of the transmitted light, the reflected light and the scattered light, and further analyze the photon statistical properties of the transmitted light, the reflected light and the scattered light.

In this embodiment, based on the measurement condition requirements of the actual sample 200, the controller controls the operation of the sample holder 1 and the coherent light source 2, such as, controls the movement of the sample holder 1 to adjust the mechanical and motion state of the sample 200, or controls the sample holder 1 to adjust the temperature of the sample 200, or controls the coherent light source 2 to emit incident light at a predetermined power, etc. By controlling the operation of the sample holder 1 and the coherent light source 2 through the controller, measurements under conditions of different temperatures, different mechanical and motion states, different chemical compositions and reaction process may be implemented. The controller obtains the data measured by the photon-number-resolving detector 2 and performs statistical analysis on the data to obtain the photon statistical properties of the transmitted light, the reflected light and the scattered light, and may obtain the current temperature, the mechanical and motion state, the chemical composition and the reaction process of the sample 200 by analyzing the photon statistical properties of the transmitted light, the reflected light and the scattered light. The measurement of the chemical composition and the reaction process, temperature, mechanical and motion state of the sample 200 based on the photon-number-resolving detector 3 may be implemented or the correspondences among the chemical composition and the reaction process, temperatures, mechanical and motion states of the sample 200 and the photon statistical properties of the transmitted light, the reflected light and the scattered light may be obtained, and the measurement of the correspondences among the chemical compositions and reaction process, temperatures, mechanical and motion states of the sample 200 and the photon statistical properties of the transmitted light, the reflected light and the scattered light based on the photon-number-resolving detector 3 may be implemented.

As shown in FIG. 2, a measurement method based on a photon-number-resolving detector of the present application performed by the measurement device based on a photon-number-resolving detector provided by above embodiments, includes the following steps:
step S10: placing a sample on a sample holder, and performing one or more operations of controlling the sample to perform chemical reactions, adjusting a temperature of the sample, and adjusting a mechanical and motion state of the sample;
step S20: controlling a coherent light source to emit incident light to the sample on the sample holder;
step S30: obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
step S40: analyzing the photon statistical properties of the transmitted light, reflected light and scattered light to obtain one or more of correspondences among a chemical composition and reaction process, a temperature, a mechanical and motion state of the sample and the photon statistical properties of the transmitted light, the reflected light, and the scattered light.

In this embodiment, the sample 200 is received through the sample holder 1, incident light is emitted toward the sample through the coherent light source 2, the photon statistical properties are obtained using the photon-number-resolving detector 3. By providing the sample holder 1 to be adjustable, the sample 200 is under different temperatures, different mechanical and motion states, different chemical compositions and reaction process, and the photon-number-resolving detector 3 is used to measure the data of the transmitted light, reflected light and scattered light passing through the sample 200 under different temperatures, different mechanical and motion states, different chemical compositions and reaction process, and to perform statistical analysis on the data to obtain the photon statistical properties of the transmitted light, the reflected light and the scattered light. As such, the correspondences among the chemical compositions and the reaction process, the temperatures, the mechanical and motion states of the sample 200 and the photon statistical properties of the transmitted light, the reflected light, and the scattered light are obtained and the measurement of the correspondences among the chemical compositions and the reaction process, the temperatures, the mechanical and motion states of the sample 200 and the photon statistical properties of the transmitted light, the reflected light, and the scattered light based on the photon-number-resolving detector 3 is implemented. The measurement method based on the photon-number-resolving detector of the present application may extend an application field of the photon-number-resolving detector 3 and effectively solve the problem that the photon-number-resolving detector 3 has relatively limited application in the measurement field in the related art.

In an embodiment, the measurement method based on the photon-number-resolving detector further includes the following steps:
step S50: placing the sample on the sample holder;
step S60: controlling a coherent light source to emit incident light to the sample on the sample holder;
step S70: obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
step S80: analyzing the photon statistical properties of the transmitted light, reflected light and scattered light based on correspondences among a chemical composition and the reaction process, the temperature, the mechanical and motion state of the sample and the photon statistical properties of the transmitted light, the reflected light, and the scattered light to obtain one or more of a current chemical composition and a current reaction process, a current temperature or a current mechanical and motion state of the sample.

In this embodiment, the data of the transmitted light, reflected light and scattered light passing through the sample 200 is measured through the photon-number-resolving detector 3 and statistical analysis is performed on the data to obtain the photon statistical properties of the transmitted light, the reflected light and the scattered light. The current chemical compositions and the reaction process, the temperatures, the mechanical and motion states of the sample 200 are obtained based on known correspondences among the chemical compositions and the reaction process, the temperatures, the mechanical and motion states of the sample 200 and the photon statistical properties of the transmitted light, the reflected light, and the scattered light and the measurement of the chemical compositions and the reaction process, the temperatures, the mechanical and motion states of the sample 200 based on the photon-number-resolving detector 3 is implemented.

It should be noted that the above embodiments are only used to explain the solutions of the present application, and are not limited thereto; although the present application has been described in detail with reference to the foregoing embodiments, it should be understood by those skilled in the art that modifications to the technical solutions documented in the foregoing embodiments and equivalent substitutions to a part of the features can be made and these modifications and substitutions do not make the corresponding solutions depart from the scope of the solutions of various embodiments of the present application.

1. A measurement device based on a photon-number-resolving detector, comprising:
a sample holder, configured to receive a sample, and further configured to accommodate the sample for performing chemical reaction, adjusting a temperature of the sample, and adjusting a mechanical and motion state of the sample;
a coherent light source, configured to emit incident light to the sample on the sample holder; and
a photon-number-resolving detector, configured to measure data of transmitted light, reflected light and scattered light passing through the sample on the sample holder and perform statistics and analysis on the data to obtain photon statistical properties of the transmitted light, reflected light and scattered light.

2. The measurement device of claim 1, wherein the sample holder comprises a sample stage and a temperature adjuster, the sample stage is configured to place the sample, the temperature adjuster is arranged on the sample stage, and the temperature adjuster is configured to adjust the temperature of the sample on the sample stage.

3. The measurement device of claim 2, wherein the temperature adjuster is configured to apply one or more of current, voltage, an acoustic field, a magnetic field or an electromagnetic wave to the sample on the sample stage for adjusting the temperature of the sample.

4. The measurement device of claim 2, wherein the sample holder further comprises a motion mechanism, wherein the motion mechanism is connected to the sample stage, and the motion mechanism is configured to drive the sample stage to perform at least one of vibration, rotation or translation.

5. The measurement device of claim 4, wherein the sample holder further comprises a loading mechanism, the loading mechanism is arranged on the sample stage, and the loading mechanism is configured to perform a loading operation of squeezing and/or stretching on the sample on the sample stage.

6. The measurement device of claim 1, wherein the coherent light source is a laser or a narrow-band filtered light-emitting diode.

7. The measurement device of claim 1, wherein the photon-number-resolving detector is any one of a superconducting transition-edge sensor, a superconducting nanowire array, a microwave dynamic inductance detector, a time division multiplexing photon-number-resolving detector, a frequency division multiplexing photon-number-resolving detector, a differential detection photon-number-resolving detector, or a spatial array photon-number-resolving detector.

8. The measurement device of claim 1, wherein both the coherent light source and the photon-number-resolving detector are configured to be movable relative to the sample holder for adjusting relative positions of both the coherent light source and the photon-number-resolving detector and the sample holder.

9. A measurement method performed by a measurement device based on a photon-number-resolving detector of claim 1, comprising:
placing a sample on a sample holder, and performing one or more operations of controlling the sample to perform chemical reactions, adjusting a temperature of the sample, and adjusting a mechanical and motion state of the sample;
controlling a coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light to obtain one or more of correspondences among a chemical composition and a reaction process, a temperature, a mechanical and motion state of the sample and the photon statistical properties of the transmitted light, the reflected light, and the scattered light.

10. The measurement method of claim 9, further comprising:
placing the sample on the sample holder;
controlling the coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light based on correspondences among the chemical composition and the reaction process, the temperature, the mechanical and motion state of the sample and the photon statistical properties of the transmitted light, the reflected light, and the scattered light to obtain one or more of a current chemical composition and a current reaction process, a current temperature or a current mechanical and motion state of the sample.

11. The measurement device of claim 2, wherein both the coherent light source and the photon-number-resolving detector are configured to be movable relative to the sample holder for adjusting relative positions of both the coherent light source and the photon-number-resolving detector and the sample holder.

12. The measurement device of claim 3, wherein both the coherent light source and the photon-number-resolving detector are configured to be movable relative to the sample holder for adjusting relative positions of both the coherent light source and the photon-number-resolving detector and the sample holder.

13. The measurement device of claim 4, wherein both the coherent light source and the photon-number-resolving detector are configured to be movable relative to the sample holder for adjusting relative positions of both the coherent light source and the photon-number-resolving detector and the sample holder.

14. The measurement device of claim 5, wherein both the coherent light source and the photon-number-resolving detector are configured to be movable relative to the sample holder for adjusting relative positions of both the coherent light source and the photon-number-resolving detector and the sample holder.

15. The measurement device of claim 6, wherein both the coherent light source and the photon-number-resolving detector are configured to be movable relative to the sample holder for adjusting relative positions of both the coherent light source and the photon-number-resolving detector and the sample holder.

16. The measurement device of claim 7, wherein both the coherent light source and the photon-number-resolving detector are configured to be movable relative to the sample holder for adjusting relative positions of both the coherent light source and the photon-number-resolving detector and the sample holder.

17. A measurement method performed by a measurement device based on a photon-number-resolving detector of claim 2, comprising:
placing a sample on a sample holder, and performing one or more operations of controlling the sample to perform chemical reactions, adjusting a temperature of the sample, and adjusting a mechanical and motion state of the sample;
controlling a coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light to obtain one or more of correspondences among a chemical composition and a reaction process, a temperature, a mechanical and motion state of the sample and the photon statistical properties of the transmitted light, the reflected light, and the scattered light.

18. The measurement method of claim 17, further comprising:
placing the sample on the sample holder;
controlling the coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light based on correspondences among the chemical composition and the reaction process, the temperature, the mechanical and motion state of the sample and the photon statistical properties of the transmitted light, the reflected light, and the scattered light to obtain one or more of a current chemical composition and a current reaction process, a current temperature or a current mechanical and motion state of the sample.

19. A measurement method performed by a measurement device based on a photon-number-resolving detector of claim 3, comprising:
placing a sample on a sample holder, and performing one or more operations of controlling the sample to perform chemical reactions, adjusting a temperature of the sample, and adjusting a mechanical and motion state of the sample;
controlling a coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light to obtain one or more of correspondences among a chemical composition and a reaction process, a temperature, a mechanical and motion state of the sample and the photon statistical properties of the transmitted light, the reflected light, and the scattered light.

20. The measurement method of claim 19, further comprising:
placing the sample on the sample holder;
controlling the coherent light source to emit incident light to the sample on the sample holder;
obtaining data of transmitted light, reflected light and scattered light passing through the sample on the sample holder measured through a photon-number-resolving detector and performing statistical analysis on the data to obtain photon statistical properties of the transmitted light, reflected light and scattered light; and
analyzing the photon statistical properties of the transmitted light, reflected light and scattered light based on correspondences among the chemical composition and the reaction process, the temperature, the mechanical and motion state of the sample and the photon statistical properties of the transmitted light, the reflected light, and the scattered light to obtain one or more of a current chemical composition and a current reaction process, a current temperature or a current mechanical and motion state of the sample.
